(19) United States
(12) Patent Application Publication
(10) Pub. No.: US 2011/0167210 A1
(43) Pub. Date: Jul. 7, 2011

(54) SEMICONDUCTOR DEVICE AND SYSTEM COMPRISING MEMORIES ACCESSIBLE THROUGH DRAM INTERFACE AND SHARED MEMORY REGION

(75) Inventor: Jin Hyoung KWON, Seongnam-si (KR)

(73) Assignee: SAMSUNG ELECTRONICS CO., LTD., Suwon-si (KR)

(21) Appl. No.: 12/868,028

(22) Filed: Aug. 25, 2010

(30) Foreign Application Priority Data
Oct. 16, 2009 (KR) 10-2009-0098524
Dec. 16, 2009 (KR) 10-2009-0125315

(51) Int. Cl. G06F 12/00

(52) U.S. Cl. 711/105; 711/112; 711/153; 711/E12.001

(57) ABSTRACT

A semiconductor device comprises a nonvolatile memory device, a memory device that processes data according to a DRAM protocol, and an ASIC that converts data output from the memory device into a format compatible with a nonvolatile memory device or a hard disk and outputs the converted data to the nonvolatile memory device or the hard disk.

### CROSS-REFERENCE TO RELATED APPLICATIONS

This application claims priority under 35 U.S.C. §119 to Korean Patent Applications Nos. 10-2009-0098524 filed on Oct. 16, 2009 and 10-2009-0125315 filed on Dec. 16, 2009, the respective disclosures of which are hereby incorporated by reference in their entirety.

### BACKGROUND

Embodiments of the inventive concept relate generally to semiconductor technology and electronics. More particularly, embodiments of the inventive concept relate to semiconductor devices and systems comprising memories accessible through a dynamic random access memory (DRAM) interface and a shared memory region.

A variety of modern electronic systems comprise one or more processors connected to one or more memory devices. The interoperation of these various elements can involve complex interfaces and protocols, and may introduce performance obstacles in the form of resource conflicts and bottlenecks. At the same time, however, the use of interoperating processors and memories presents opportunities for enhanced performance due to relative strengths of the different components.

### SUMMARY

Embodiments of the inventive concept provide devices and systems in which a nonvolatile memory device and a magnetic recording medium are accessed through a DRAM interface and a shared memory region. Embodiments of the inventive concept also provide apparatuses and methods for processing data between a memory device and processors at high speed.

According to one embodiment of the inventive concept, a semiconductor system comprises a central processing unit, a nonvolatile memory device, a magnetic recording medium, a memory device, and an application specific integrated circuit. The memory device processes data output from the CPU according to a dynamic random access protocol and outputs the processed data. The application specific integrated circuit converts data output from the memory device into a format compatible with the nonvolatile memory device and a format compatible with the magnetic recording medium.

In certain embodiments, the application specific integrated circuit comprises a first controller that communicates with the memory device according to the dynamic random access memory protocol, a second controller that converts data output from the first controller into a format compatible with the nonvolatile memory device, a third controller that converts the data output from the first controller into data compatible with the magnetic recording medium, and a main processor that selectively enables the second controller and the third controller according to selection information output from the central processing unit.

In certain embodiments, the application specific integrated circuit further comprises a fourth controller that converts data output from the second controller or the third controller into a format to be processed by a module under the control of the main processor.

In certain embodiments, the module is a computer expansion card, a display device, an MP3 player, or a universal serial bus device.

In certain embodiments, the semiconductor system further comprises a graphic card that reads data stored in the nonvolatile memory device or the magnetic recording medium through the application specific integrated circuit.

In certain embodiments, the semiconductor system further comprises a universal serial bus device that reads data stored in the nonvolatile memory device or the magnetic recording medium through the application specific integrated circuit.

In certain embodiments, the memory device comprises a first memory bank that can be accessed by the central processing unit, a second memory bank that can be accessed by the application specific integrated circuit, and a shared memory bank that can be accessed by the central processing unit or the application specific integrated circuit according to an access authority. The data output from the central processing unit is transferred to the application specific integrated circuit via the shared memory bank.

In certain embodiments, the nonvolatile memory device, the memory device, and the application specific integrated circuit are incorporated in a single integrated circuit.

In certain embodiments, the nonvolatile memory device comprises a flash memory device.

In certain embodiments, the magnetic recording medium comprises a hard disk.

According to another embodiment of the inventive concept, a semiconductor device comprises a nonvolatile memory device, a memory device that processes data according to a dynamic random access memory protocol, and an application-specific integrated circuit that converts data output from the memory device into a format compatible with the nonvolatile memory device and a format compatible with a hard disk.

In certain embodiments, the application specific integrated circuit comprises a first controller that communicates with the memory device according to the dynamic random access memory protocol, a second controller that converts data output from the first controller into the format compatible with the nonvolatile memory device, a third controller that converts the data output from the first controller into the format compatible with the hard disk, and a main processor that selectively enables the second controller and the third controller according to selection information.

In certain embodiments, the nonvolatile memory device, the memory device, and the application specific integrated circuit are implemented in a multi chip package.

In certain embodiments, the application specific integrated circuit further comprises a fourth controller that converts data output from the second controller or the third controller into a format compatible with a module that operates under the control of the main processor.

In certain embodiments, the semiconductor device further comprises a shared memory region that receives memory access commands from the application specific integrated circuit and the central processing unit and provides access to the memory access commands according to an access authority.

In certain embodiments, the shared memory region resides in a multi-port memory device having a first port providing access to the application specific integrated circuit and a second port providing access to the central processing unit.

According to still another embodiment of the inventive concept, a semiconductor system comprises a nonvolatile memory device, a magnetic recording medium, a memory device comprising a first storage area and a second storage area, a first processor that inputs an access command to the memory device for storage in the first storage area and inputs data corresponding to the access command to the memory device for storage in the second storage area, and a second processor that reads the access command from the first storage area, and performs a data access operation on the nonvolatile memory device or the magnetic recording medium according to the access command.

In certain embodiments, the memory device further comprises a third storage area for storing an index indicating a size of the access command.

In certain embodiments, the memory device further comprises a register block that stores messages transmitted between the first processor and the second processor.

In certain embodiments, the first processor comprises a central processing unit that inputs the access command to the memory device using a dynamic random access memory protocol, and wherein the second processor comprises an application specific integrated circuit that reads the access command from the memory device using the dynamic random access memory protocol.

### BRIEF DESCRIPTION OF THE DRAWINGS

The drawings illustrate selected embodiments of the inventive concept. In the drawings, like reference numbers indicate like features.

FIG. 1 is a block diagram of a semiconductor system according to an embodiment of the inventive concept.

FIG. 2 is a block diagram of a multi-port memory device illustrated in FIG. 1.

FIG. 3 is a memory diagram illustrating an example memory map of a shared memory bank in FIG. 2.

FIG. 4 is a block diagram of an application specific integrated circuit (ASIC) illustrated in FIG. 1.

FIG. 5 is a block diagram of a semiconductor system according to another embodiment of the inventive concept.

FIG. 6 is a block diagram of an ASIC illustrated in FIG. 5.

FIG. 7 is a block diagram of a semiconductor system according to another embodiment of the inventive concept.

FIG. 8 is a flowchart illustrating a data processing method according to an embodiment of the inventive concept.

FIG. 9 is a block diagram of a semiconductor system according to another embodiment of the inventive concept.

FIG. 10 is a memory diagram illustrating another example memory map of the shared memory bank in FIG. 2.

FIG. 11 is a block diagram of a second processor illustrated in FIG. 9.

FIG. 12 is a diagram of a data packet that can be used in the semiconductor system of FIG. 9.

FIG. 13 is a flowchart illustrating a method of performing a write operation in the semiconductor system of FIG. 9.

FIGS. 14a through 14f are memory diagrams illustrating data processing procedures of a memory device in FIG. 9.

FIG. 15 is a flowchart for explaining a read operation of the semiconductor system of FIG. 9.

### DETAILED DESCRIPTION OF EMBODIMENTS

Embodiments of the inventive concept are described below with reference to the accompanying drawings. These embodiments are presented as teaching examples and should not be construed to limit the scope of the inventive concept.

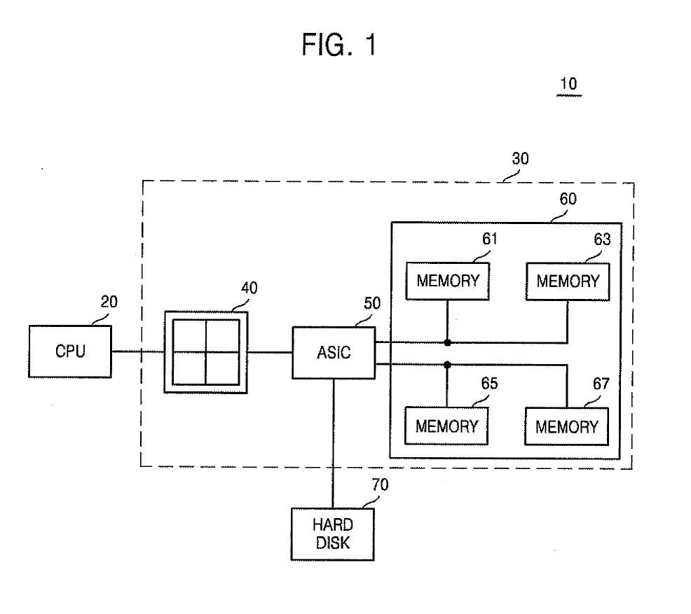

FIG. 1 is a block diagram of a semiconductor system 10 according to an embodiment of the inventive concept. Referring to FIG. 1, semiconductor system 10 comprises a CPU 20, a multi-port memory device 40, an ASIC 50, a nonvolatile memory device 60, and a magnetic recording medium 70 such as a hard disk.

In the embodiment of FIG. 1, multi-port memory device 40, ASIC 50 and nonvolatile memory device 60 are incorporated in a single chip 30 forming a memory link architecture (MLA). In other embodiments, however, these features can be formed in separate chips. Moreover, in various embodiments, these features can be incorporated in a multi-chip package (MCP).

Semiconductor system 10 can be incorporated in any of several types of electronic devices employing a nonvolatile memory device and a magnetic recording medium. For example, semiconductor system 10 can be incorporated in a personal computer (PC), a tablet PC, a net-book, a note PC, a mobile phone, a smart phone, a memory card, or various types of consumer equipment (CE). The CE can comprise, for instance a digital television (TV), an internet protocol TV (IPTV), a refrigerator, a home automation system, a navigation device, or a washing machine.

CPU 20 accesses nonvolatile memory device 60 or magnetic recording medium 70 through a DRAM interface and a shared memory bank of multi-port memory device 40. For example, CPU 20 accesses nonvolatile memory device 60 through multi-port memory device 40 and ASIC 50, both of which comprise a DRAM interface. Similarly, CPU 20 accesses access magnetic recording medium 70 through multi-port memory device 40 and ASIC 50.

In some embodiments, an operating system OS of CPU 20 recognizes nonvolatile memory device 60 and magnetic recording medium 70 as different drives according to a user setting or input. For instance, in some embodiments, CPU 20 recognizes nonvolatile memory device 60 as a “B” drive and magnetic recording medium 70 as a “C” drive based on a user setting or input.

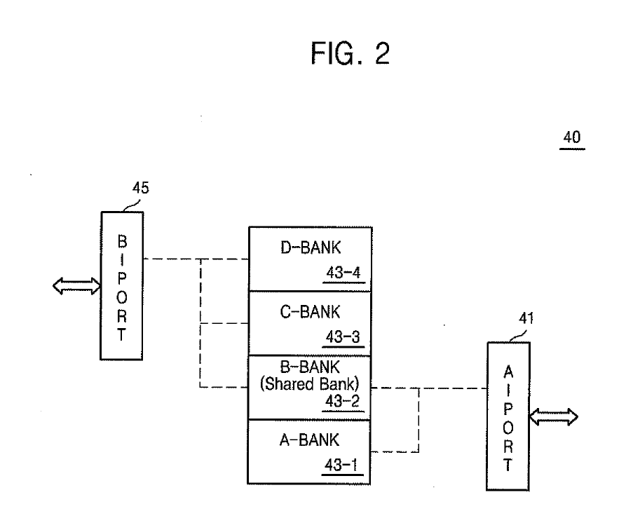

FIG. 2 is a block diagram of an embodiment of multi-port memory device 40. Referring to FIGS. 1 and 2, multi-port memory device 40 comprises a first port or A-port 41 connected to ASIC 50, a plurality of memory banks 43-1, 43-2, 43-3 and 43-4, and a second port or B-port 45 connected to CPU 20.

First port 41 and second port 45 are controllers or interfaces that send or receive data using a DRAM protocol. Memory bank 43-1 is dedicated to ASIC 50 and can be accessed by ASIC 50 through first port 41. Memory banks 43-3 and 43-4 are dedicated to CPU 20 and can be accessed by CPU 20 through second port 45.

Memory bank 43-2 is a shared memory bank or region that can be accessed by ASIC 50 through first port 41 or by CPU 20 through second port 45 according to an access authority. Multi-port memory device 40 processes data, such as read and write data, according to the DRAM protocol.

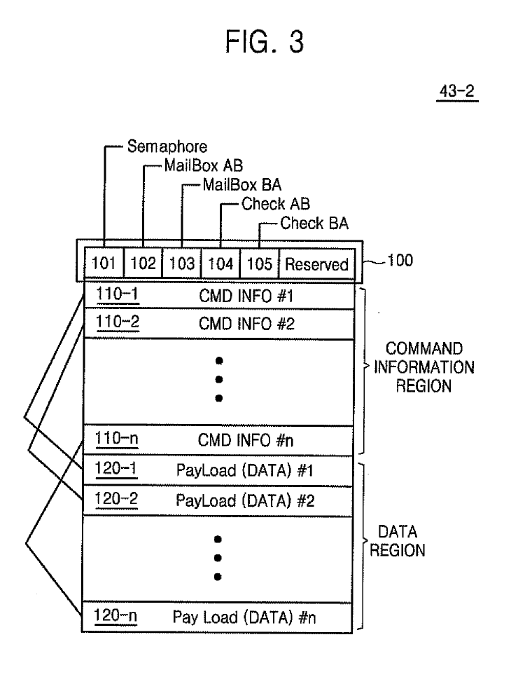

FIG. 3 is a memory diagram illustrating an example memory map of shared memory bank 43-2 of FIG. 2. Referring to FIGS. 1 through 3, shared memory bank 43-2 comprises a plurality of registers. The registers comprise internal registers 101 through 105 and reserved registers. The registers provide storage space corresponding to a row size, such as N-KB, where “N” is a natural number such as 2. In certain embodiments, multi-port memory device 40 receives a specific row addresses from CPU 20, and a specific region of shared memory bank 43-2 is set aside for use as internal registers 101 through 105.

Internal registers 101 through 105 comprise a semaphore register 101, mailbox registers 102 and 103, and check registers 104 and 105. Internal registers 101 through 105 are used to address conflict situations that arise where CPU 20 and ASIC 50 attempt to access shared memory bank 43-2 at the same time. These conflict situations are addressed by providing an access authority and data transmission capability to first port 41 and second port 45 using data stored in internal registers 101 through 105. For instance, semaphore register 101 can store a bit indicating one of first port 41 or second port 45 that has access authority for shared memory bank 43-2. In one example, a value “1” in semaphore register 101 indicates that second port 45 has access authority for shared memory bank 43-2, while a value “0” in semaphore register 101 indicates that first port 41 has access authority for shared memory bank 43-2. In other embodiments, opposite values are used to indicate the access authority of first port 41 and second port 45.

The value of semaphore register 101 is typically written only by a port having the access authority. In certain embodiments, semaphore register 101 comprises a one-bit register or a two-bit register, but it is not restricted to one or two bit registers.

Mail box registers 102 and 103 are used for transmitting messages to and from ASIC 50 and CPU 20, such as a location and a size of data to be written or read, commands, and so forth. As an example, to transmit a message from ASIC 50 connected to first port 41 to CPU 20 connected to second port 45, ASIC 50 writes a message in mail box register 102, and the message is subsequently read by CPU 20. On the other hand, to transmit a message from CPU 20 connected to second port 45 to ASIC 50 connected to first port 41, CPU 20 writes a message in mail box register 103 and ASIC 50 reads the message.

Where a message is written in mail box register 102 or 103, an interrupt signal is occurs. For example, where a message is written in mail box register 102, an interrupt signal is transmitted to CPU 20 through second port 45. CPU 20 reads a message written in mail box register 102 in response to the interrupt signal and performs an action according to the message, such as reading command information stored in a first command information region 110-1, and/or a payload or data stored in a first data region 120-1.

Similarly, where a message is written in mail box register 103, an interrupt signal is transmitted to ASIC 50 through first port 41. In response to the interrupt signal, ASIC 50 reads a message written in mail box register 103, and performs an action according to the message, such as reading command information stored in a second command information region 110-2, and/or a payload or data stored in a second data region 120-2.

A value of each check register 104 and 105 indicates whether a message written in each mail box register 102 and 103 has been read by an opposite port. A value of each check register 104 and 105 is changed automatically upon input or output of messages in mail box registers 102 and 103. For example, where ASIC 50 writes a message in mail box register 102, a value of check register 104 is set to ‘1’, and where CPU 20 reads the message from mail box register 102, the value of check register 104 is set to ‘0’.

CPU 20 and ASIC 50 exchange access authority for shared memory bank 43-2 using a process described below. In the following example, the access authority is transferred from CPU 20 to ASIC 50.

For explanation purposes, it will be assumed that initial value of semaphore register 101 is set to “1” to indicate that CPU 20 has access to shared memory bank 43-2 through second port 45. CPU 20 also has access to dedicated memory banks 43-3 and 43-4 through second port 45 because these banks are dedicated to CPU 20. Meanwhile, ASIC 50 initially has access to dedicated memory bank 43-1, but not access shared memory bank 43-2.

In a first step, CPU 20 reads the value “1” of semaphore register 101 through second port 45 to check the access authority for shared memory bank 43-2. Upon detecting the value “1” of semaphore register 101, CPU 20 detects that it has access authority.

In a second step, ASIC 50 writes a message in mail box register 102 through first port 41 to request a change of access authority change for shared memory bank 43-2. An interrupt signal is generated in response to the message written in mail box register 102 to inform CPU 20 of the existence of the message.

In a third step, CPU 20 reads the message written in mail box register 102 through second port 45 in response to the interrupt signal.

In a fourth step, CPU 20 changes the value of semaphore register 101 from “1” to “0” through second port 45. CPU 20 then writes a message in mail box register 103 to indicate that the value of semaphore register 101 has changed from “1” to “0”, and an interrupt signal is generated and transmitted to ASIC 50 to indicate the existence of the message in mail box register 103. In response to the interrupt signal, ASIC 50 reads a message written in mail box register 103 through first port 41.

In a fifth step, ASIC 50 reads a value of semaphore register 101 through first port 41 to determine that the access authority for shared memory bank 43-2 has changed. Upon confirming the change of access authority, ASIC 50 accesses shared memory bank 43-2 through first port 41.

As illustrated in FIG. 3, command information output from CPU 20 or ASIC 50, such as read and write commands, and read and write addresses, is stored in command information regions 110-1 through 110-n and data regions 120-1 through 120-n. Moreover, corresponding command information regions and data regions can be used to store corresponding data, such as a read command and a corresponding read address. For instance, first command information region 110-1 and first data region 120-1 correspond to each other, second command information region 110-2 and second data region 120-2 correspond to each other, and n^{th} command information region 110-n and n^{th} data region 120-n correspond to each other.

After ASIC 50 obtains access authority for shared memory bank 43-2, ASIC 50 accesses shared memory bank 43-2 and reads data stored in shared memory bank 43-2. ASIC 50 typically writes the stored data in nonvolatile memory device 60 or in magnetic recording medium 70 according to a command output from CPU 20.

ASIC 50 typically converts a protocol of data read from shared memory bank 43-2 to a protocol of nonvolatile memory device 60 or magnetic recording medium 70 and transmits data having the converted protocol to nonvolatile memory device 60 or magnetic recording medium 70. By converting between the original protocol and the protocol of nonvolatile memory device 60 or magnetic recording medium 70, ASIC 50 can support three different communication protocols. To perform such conversions, ASIC 50 can comprise three controllers or interfaces corresponding to the different protocols. Each interface can comprise, for instance, hardware, software, or a combination thereof.

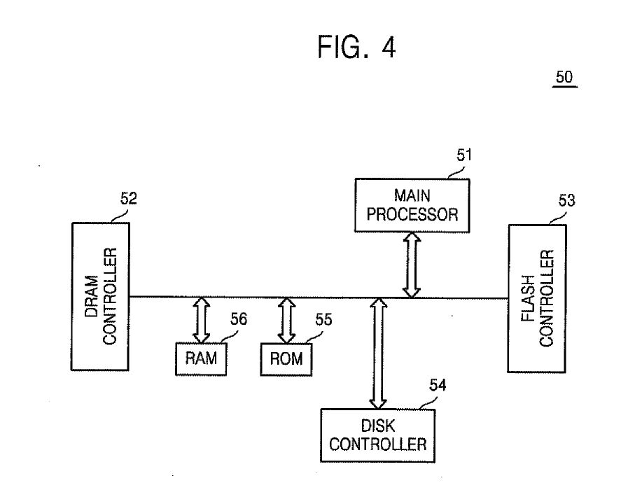

FIG. 4 is a block diagram illustrating an embodiment of ASIC 50. In the embodiment of FIG. 4, ASIC 50 comprises a main processor 51, first through third controllers 52, 53, 54, a ROM 55, and a RAM 56.

First controller 52 is a controller or an interface that exchanges command information such as read and write command information, address information such as read and write addresses, and data such as read and write data, with first port 41 illustrated in FIG. 2. First controller 52 sends and receives command information, addresses, and data via first port 41 under the control of main processor 51.

First controller 52 comprises a controller or interface that supports or uses a DRAM communication protocol. Second controller 52 further comprises a controller or interface that exchanges command information, addresses, or data with nonvolatile memory device 60 according to a protocol of nonvolatile memory device 60.

Nonvolatile memory device 60 comprises a plurality of nonvolatile memories 61, 63, 65, and 67. Nonvolatile memories 61, 63, 65, and 67 each comprise a plurality of nonvolatile memory cells.

In various alternative embodiments, each nonvolatile memories 61, 63, 65, and 67 comprises one or more of an electrically erasable programmable read-only memory (EEPROM), a flash memory, a magnetic RAM (MRAM), a spin-transfer torque (MRAM), a conductive bridging RAM (CBRAM), a ferroelectric RAM (FeRAM), a phase change RAM (PRAM), a resistive RAM (RRAM or ReRAM), a nano-tube RRAM, a polymer RAM (PoRAM), a nano floating gate memory (NFGM), a holographic memory, a molecular electronics memory device and an insulator resistance change memory. In various embodiments, each of the plurality of nonvolatile memory cells can store one or more bits of data.

Second controller 53 comprises a controller or an interface that supports or uses a flash memory communication protocol. In certain embodiments, second controller 53 supports or uses a communication protocol for nonvolatile memory cells in nonvolatile memory device 60.

Third controller 54 comprises a controller or interface that exchanges command information, addresses, and data with magnetic recording medium 70. In certain embodiments, third controller 54 comprises a controller or interface that supports or uses an advanced technology attachment (ATA) interface, a serial ATA (SATA) interface, or a parallel ATA (PATA) interface.

In a booting operation, main processor 51 transfers boot code from ROM 55 to RAM 56, and executes the boot code. When executing the boot code, main processor 51 transfers data stored in shared memory bank 43-2 to nonvolatile memory device 60 through second controller 53 or transmits data to magnetic recording medium 70 through third controller 54. Main processor 51 also transfers data from shared memory bank 43-2 to nonvolatile memory device 60 or magnetic recording medium 70 in response to commands input through first controller 52.

In various embodiments, ASIC 50 and main processor 51 are used to manage a file system to be stored in nonvolatile memory device 60 or in magnetic recording medium 70.

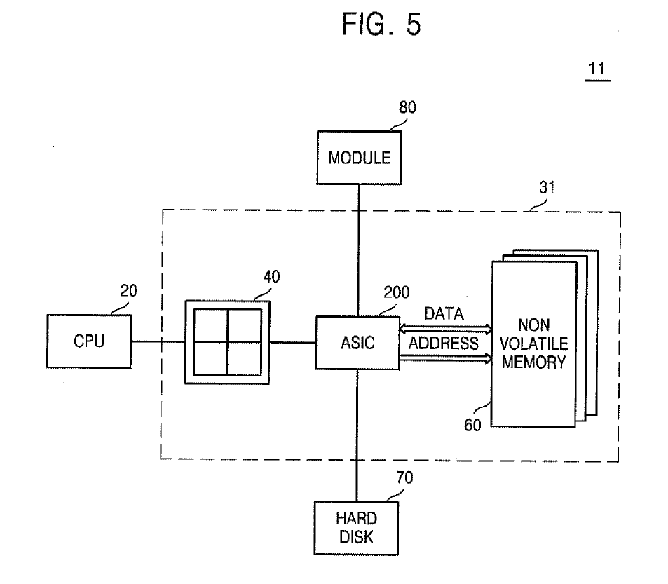

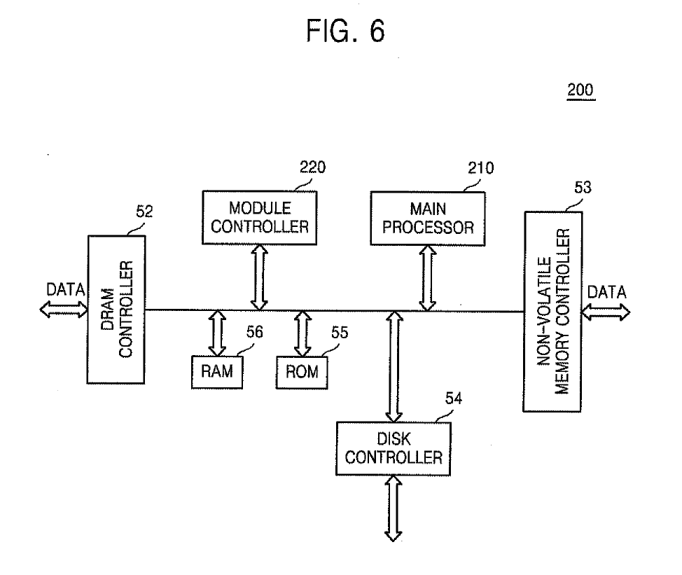

FIG. 5 is a block diagram of a semiconductor system 11 according to another embodiment of the inventive concept. Referring to FIG. 5, system 11 comprises CPU 20, multi-port memory device 40, an ASIC 200, nonvolatile memory device 60, magnetic recording medium 70, and a module 80. In contrast to ASIC 50 of FIG. 1, ASIC 200 supports four different communication protocols and comprises four different controllers or interfaces for implementing the protocols, as explained in further detail with reference to FIG. 6.

In the embodiment of FIG. 5, multi-port memory device 40, ASIC 200, and nonvolatile memory device 60 are implemented in a single chip 31, which forms an MLA. In other embodiments, these features can be formed in separate chips. Moreover, in various embodiments, these features can be incorporated in an MCP.

FIG. 6 is a block diagram illustrating an embodiment of ASIC 200 of FIG. 5. In the embodiment of FIG. 6, ASIC 200 comprises a main processor 210, first through fourth controllers 52, 53, 54 and 220, ROM 55 and RAM 56.

Referring to FIGS. 2, 5, and 6, main processor 210 controls transmission of data stored in shared memory bank 43-2 to nonvolatile memory device 60 through second controller 53, transmission of the data to magnetic recording medium 70 through third controller 54, or transmission to module 80 through fourth controller 220 by interpreting a command input through first controller 52. In other words, main processor 210 controls the operation of controllers 52, 53, 54 and 220. Fourth controller 220 is a controller or an interface that exchanges command information, addresses, and data with module 80.

In some embodiments, module 80 comprises a computer expansion card such as a graphic card, and fourth controller 220 comprises a controller or an interface that supports or uses a peripheral component interconnect express (PCI) standard to communicate with module 80. In such embodiments, fourth controller 220 converts data output from CPU 20, nonvolatile memory device 60, or magnetic recording medium 70 to a format suitable for the computer expansion card and transmits the converted data to the computer expansion card. Accordingly, the computer expansion card can read data from nonvolatile memory device 60 or magnetic recording medium 70 through ASIC 200.

In some embodiments, module 80 comprises a flat panel display such as an LCD screen, an LED display, an OLED display, or a PDP display, and fourth controller 220 comprises a controller or interface that supports or uses a protocol for transmitting data to the flat panel display. In such embodiments, fourth controller 220 converts data output from CPU 20, nonvolatile memory device 60 or magnetic recording medium 70 to a format suitable for the flat panel display and transmits the converted data to the flat panel display under the control of main processor 210.

In some embodiments, module 80 comprises a USB device, and fourth controller 220 comprises a controller or interface that supports or uses a protocol, such as RS232, for transmitting data to the USB device. In some embodiments, module 80 comprises an MP3 player or an MP4 player and fourth controller 220 comprises a controller or interface that supports or uses a protocol for transmitting data to the MP3 player or the MP4 player.

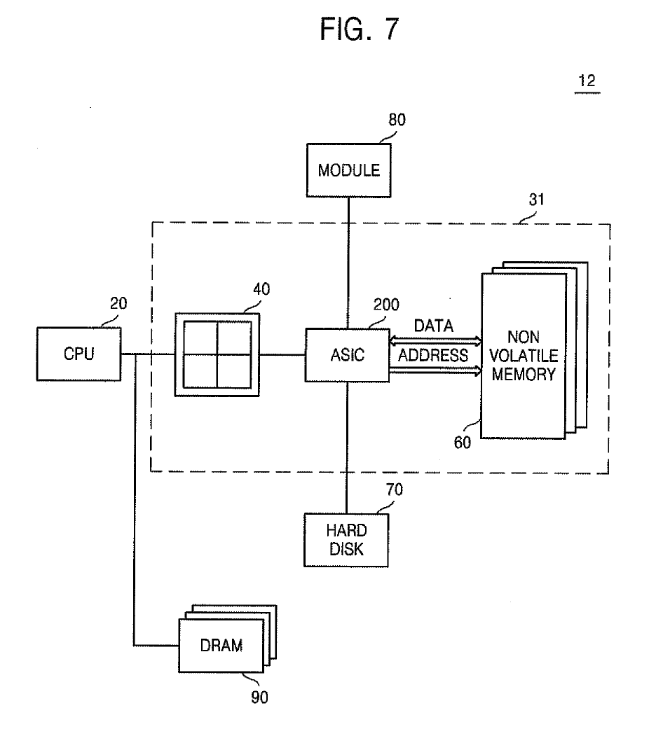

FIG. 7 is a block diagram of a semiconductor system 12 according to still another embodiment of the inventive concept. Referring to FIG. 7, system 12 is similar to system 11, except that system 12 further comprises at least one memory device 90 connected to CPU 20 as an upgrade. The at least one memory device 90 typically comprises a memory device such as a DRAM module.

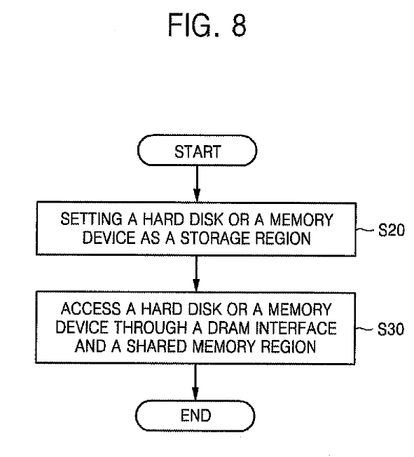

FIG. 8 is a flowchart illustrating a data processing method according to an embodiment of the inventive concept. The method of FIG. 8 will be explained with reference to FIGS. 1 through 8. More specifically, the method will be explained with reference to an operation in which CPU 20 accesses nonvolatile memory device 60 or magnetic recording medium 70 through a DRAM interface and shared memory bank 43-2 of multi-port memory device 40.

In the method of FIG. 8, a user sets nonvolatile memory device 60 or magnetic recording medium 70 as a storage medium for storing data by using OS stored in CPU 20 (S20). For example, where CPU 20 has an access authority for shared memory bank 43-2 and nonvolatile memory device 60 is selected as a data storage medium by the user or CPU 20, CPU 20, which is connected to second port 45 of multi-port memory device 40 stores a write command and related address information in first command information region 110-1, stores corresponding write data in first data region 120-1, and writes a message in mail box register 103 to indicate the presence of the write command information and write data in regions 110-1 and 120-1. The addresses in the write command information indicate locations in shared memory bank 43-2 and nonvolatile memory device 60 where the write data is to be stored.

After the message is written in mail box register 103, an interrupt signal is transmitted to main processor 51 through first port 41 and first controller 52. Upon receiving the interrupt signal, main processor 51 reads and decodes the command and address information stored in first command information region 110-1 and reads write data written in the first data region 120-1 according to the decoded command and address information. Main processor 51 then writes the write data in nonvolatile memory device 60 through second controller 53 (S30).

In some embodiments, main processor 51 generates an enable signal or a disable signal according to selection information output from CPU 20. Second controller 53 becomes enabled in response to the enable signal and third controller 54 becomes disabled in response to the disable signal. The selection information can be information received from a user.

Where CPU 20 has access authority for shared memory bank 43-2, and magnetic recording medium 70 is selected as a data storage medium by an user or CPU 20, CPU 20 stores write command information comprising a write command and related address information in first command information region 110-1, stores write data in first data region 120-1, and writes a message to mail box register 103 to indicate the presence of the write command information and write data in regions 110-1 and 120-1. The addresses in the write command information indicate locations in shared memory bank 43-2 and magnetic recording medium where the write data is to be stored.

After the message is written in mail box register 103, an interrupt signal is transmitted to main processor 51 through first port 41 and first controller 52. In response to the interrupt signal, main processor 51 reads and decodes the write command and related addresses stored in first command information region 110-1, and reads the write data stored in first data region 120-1 according to the decoded write command. Main processor 51 stores the writes data in magnetic recording medium 70 through third controller 54 (S30).

In some embodiments, main processor 51 generates an enable signal and a disable signal according to selection information output from CPU 20. Second controller 53 becomes disabled in response to the disable signal output from main processor 51, and third controller 54 becomes enabled in response to the enable signal output from main processor 51. The selection information can be information received from a user.

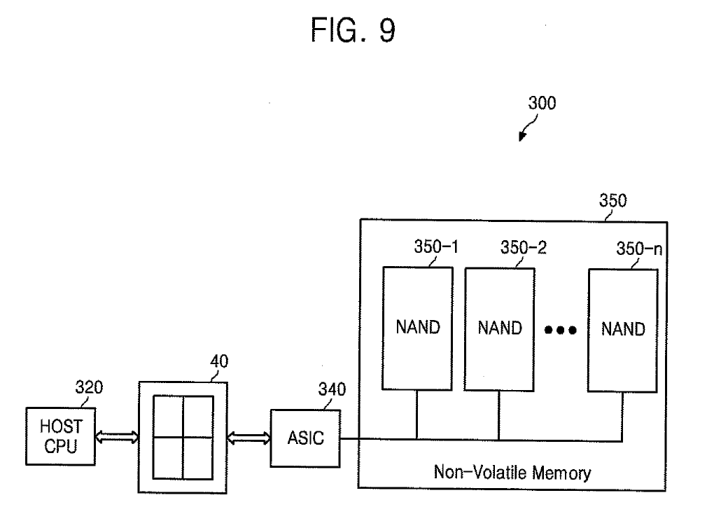

FIG. 9 is a block diagram of a semiconductor system 300 according to yet another embodiment of the inventive concept. Referring to FIG. 9, semiconductor system 300 comprises a first processor 320, multi-port memory device 40, a second processor 340 and a nonvolatile memory device 350. Semiconductor system 300 can be implemented by any of several types of electronic devices, such as a personal computer, a laptop computer, a net-book, an e-book, a memory card, a smart card, a cellular phone, a personal digital assistant, a portable multimedia player, or a digital TV, to name but a few.

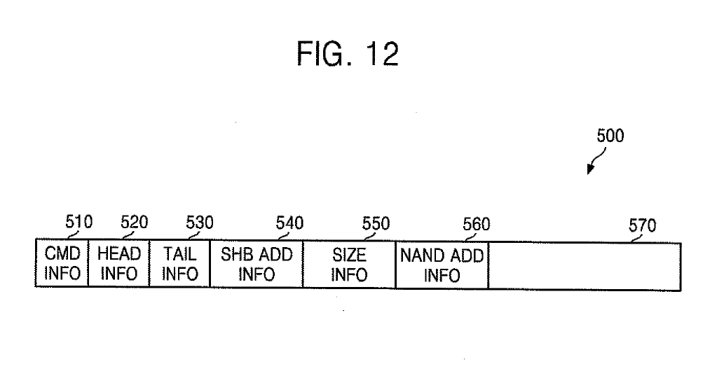

In some embodiments, first processor 320 comprises a host CPU and generates a data packet 500 as illustrated in FIG. 12. First processor 320 transmits data packet 500 to multi-port memory device 40. In some embodiments, first processor 320 generates a plurality of data packets and transmits the generated data packets to multi-port memory device 40 in order.

As indicated by the description of FIGS. 1-8, multi-port memory device 40 stores access commands and command data, such as write data to be written in various memory devices. In the embodiment of FIG. 9, the access stored commands and command data correspond to operations to be performed on nonvolatile memory device 350.

Second processor 340 can be implemented by an ASIC, and can be used to access nonvolatile memory device 350 according to various access commands. For example, second processor 340 can perform a write operation by transferring write data from shared memory bank 43-2 to nonvolatile memory device 350 according to an access command stored in shared memory bank 43-2. Second processor 340 can also perform a read operation to read data from nonvolatile memory device 350 according to an access command stored in shared memory bank 43-2 and store the read data in shared memory bank 43-2.

Nonvolatile memory device 350 comprises a plurality of memory blocks 350-1 through 350-n. Memory blocks 350-1 through 350-n each comprise a plurality of memory cells. In certain embodiments, memory blocks 350-1 through 350-n are arranged in a configuration where multiple memory blocks share one or more communication channels.

In some embodiments, second processor 340 and nonvolatile memory device 350 are implemented as separate chips and arranged in an MCP. In other embodiments, multi-port memory device 40, second processor 340 and nonvolatile memory device 350 are implemented in a single chip forming an MLA and arranged in an MCP.

In some embodiments, first and second processors 320 and 340 store and access data in shared memory bank 43-2 at different data rates. Additionally, in some embodiments, second processor 340 stores and accesses data in nonvolatile memory device 350 at a different rate from the rate used by first processor 320 to store and access data in shared memory bank 43-2. For instance, second processor 340 can use a lower data rate to store and access data in shared memory bank 43-2 and in nonvolatile memory device 350 than first processor 320 uses to store and access data in shared memory bank 43-2.

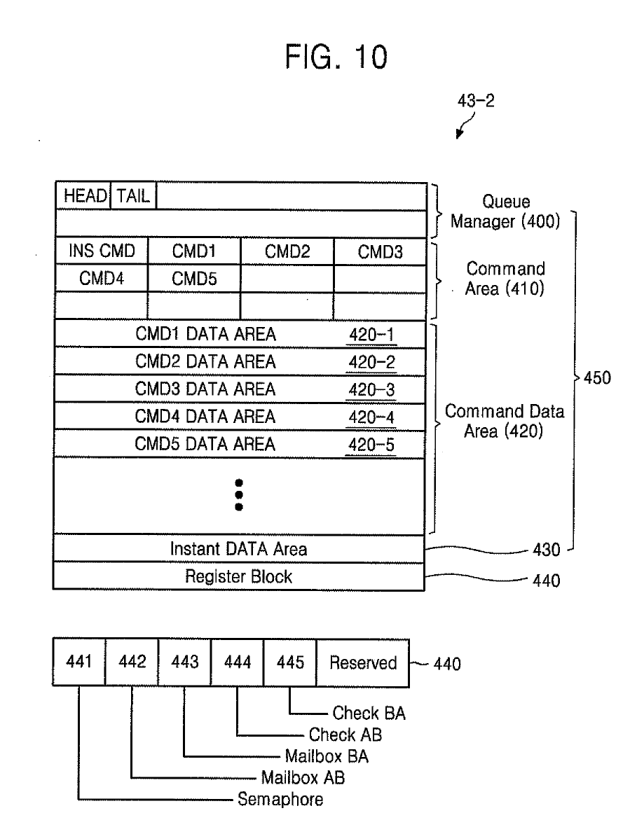

FIG. 10 is a memory diagram illustrating another embodiment of a memory map of shared memory bank 43-2 illustrated in FIG. 2. In the embodiment of FIG. 10, shared memory bank 43-2 comprises a control block 450 and a register block 440.

Control block 450 comprises a queue manager area 400 or an index storage area 400, a command area 410, a command data area 420, and an instant data area 430.

Queue manager area 400 stores a start command index HEAD and an end command index TAIL of a data packet. This information can be used, for instance, to manage information stored in command data area 420 or command area 410. As an example, start command index HEAD and end command index TAIL can be used to determine a number of access commands in command area 410 and/or an amount of data stored in command data area 420.

Command area 410 stores an instant command INS CMD and a plurality of access commands CMD1, CMD2, CMD3, CMD4, CMD5, etc. Command data area 420 stores command data, such as write or read data that corresponds to each access command. For example, first command data corresponding to a first access command CMD1 can be stored in a first command data storage area 420-1, a second command data corresponding to a second access command CMD2 can be stored in a second command data storage area 420-2, a third command data corresponding to a third access command CMD3 can be stored in a third command data storage area 420-3, and so on.

For a write operation, the access command comprises a write command, an address of shared memory bank 43-2 where write data is stored, and an address of nonvolatile memory device 350 where the write data is to be stored. For a read operation, the access command comprises a read command, an address of shared memory bank 43-2 where read data is to be stored, and an address of nonvolatile memory device 350 where the read data is stored. In certain embodiments, command data corresponding to instant command INS CMD is stored in instant data area 430.

Register block 440 comprises elements for facilitating transmission of messages between first processor 320 and second processor 340.

Register block 440 comprises a plurality of internal registers 441 through 445, and a plurality of reserved registers. Register block 440 typically has a size corresponding to a row size, such as N-KB, where “N” is a natural number such as 2. Where multi-port memory device 40 receives a specific row address from first processor 320, a specific memory area of shared memory bank 43-2 is set aside for use as internal registers 441 through 445.

Internal registers 441 through 445 comprise a semaphore register 441, mail box registers 442 and 443, and check registers 444 and 445.

Internal registers 441 through 445 have functions similar to respective internal registers 101 through 105 of FIG. 3. In particular, semaphore register 441 has a function similar to semaphore register 101, mail box registers 442 and 443 have functions similar to mail box registers 102 and 103, and check registers 144 and 145 have functions similar to check registers 104 and 105.

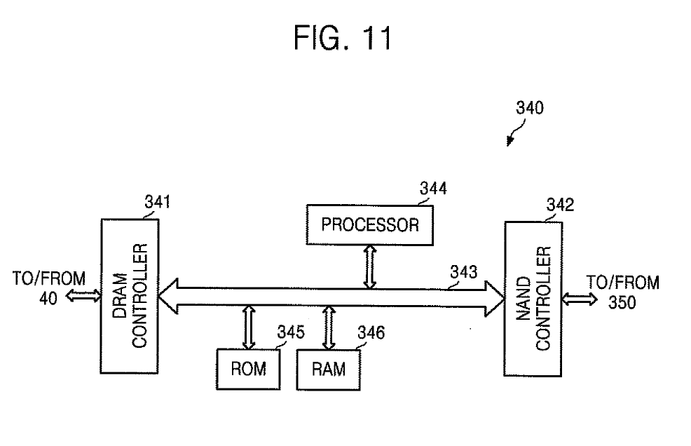

FIG. 11 is a block diagram of an embodiment of second processor 340 of FIG. 9. In the embodiment of FIG. 11, second processor 340 comprises first and second controllers 341 and 342, a processor 344, a ROM 345, and a RAM 346.

First controller 341 is a controller or an interface that communicates with first port 41 of FIG. 2. First controller 341, under the control of processor 344, reads an access command stored in command area 410, and reads write data stored in command data area 420 or read data stored in command data area 420 from nonvolatile memory device 350 according to the access command. In certain embodiments, first controller 341 comprises a controller or an interface that supports or uses a DRAM protocol.

Second controller 342 comprises a controller or an interface that transmits write data to nonvolatile memory device 350 or receives read data from nonvolatile memory device 350. In certain embodiments, second controller 342 comprises a NAND flash controller or interface. During booting, processor 344 loads a program from ROM 345 to RAM 346 and executes the loaded program. Processor 344 can use the program to control the operation of controllers 341 and 342.

FIG. 12 illustrates an example of a data packet 500 that can be used in semiconductor system 300 of FIG. 9. Referring to FIGS. 9 and 12, first processor 320 generates data packet 500 to be stored in shared memory bank 43-2 during read and write operations to provide information between different elements of system 300. Data packet 500 comprises a plurality of information areas 510 through 560.

A first information area 510 stores command information, such as a read or write command and related address information. A second information area 520 stores a start command index, and a third information area 530 stores an end command index. The start command index and the end command index indicate a number of access commands received from first processor 320. In some embodiments, memory system 300 processes the multiple access commands in succession.

A fourth information area 540 stores an address of shared memory bank 43-2 where command data is stored or will be stored, and a fifth information area 550 stores a size of data that is stored or will be stored in shared memory bank 43-2. A sixth information area 560 stores an address of nonvolatile memory device 350 where write data will be stored during a write operation, or an address where read data that is read from the nonvolatile memory 350 will be stored during a read operation. An access command typically comprises information stored in each of information areas 510, 540, 550 and 560.

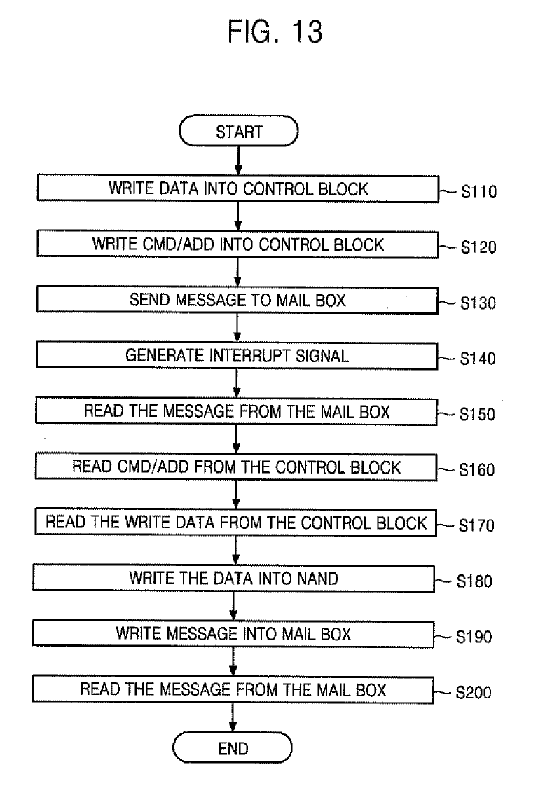

FIG. 13 is a flowchart illustrating a method of performing a write operation in semiconductor system 300 of FIG. 9. The method of FIG. 13 is explained below with reference to FIGS. 9 through 13.

In the method of FIG. 13, it is assumed that first processor 320 initially has access authority for shared memory bank 43-2. Accordingly, first processor 320 stores write data in control block 450 through second port 45 (S110). For instance, the write data can be stored in first command data area 420-1 of command data area 420. Thereafter, first processor 320 generates data packet 500 for the write data and transmits the generated data packet to multi-port memory device 40. Multi-port memory device 40 samples or extracts an access command from data packet 500 and writes the access command in command area 410 of control block 450 (S120).

First processor 320 then writes a message in mail box register 443 through second port 45 (S130). Then, multi-port memory device 40 transmits an activated interrupt signal to second processor 340 through first port 41 to indicate the presence of the message in mail box register 443. In response to the interrupt signal, second processor 340 performs operations to obtain the access authority for shared memory bank 43-2 from first processor 320.

After second processor 340 obtains access authority for shared memory bank 43-2, processor 344 of second processor 340 reads the message stored in mail box register 443 (S150). Based on the message, second processor 340 then reads an access command stored in command area 410 of control block 450 (S160). Second processor 340 decodes the access command, reads write data stored in first command data area 420-1 of command data area 420 according to the decoded access command, and stores the write data in nonvolatile memory device 350 using second controller 342 (S180).

After the write operation is completed, controller 344 of second processor 340 writes a message in mail box register 442 by using first port 41 to indicating that the write operation is completed (S190). Multi-port memory device 40 then transmits an activated interrupt signal to first processor 320 to indicate the presence of the message in mail box register 442. In response to the interrupt signal, first processor 320 performs operations to obtain access authority for shared memory bank 43-2.

After obtaining access authority for shared memory bank 43_2, first processor 320 reads a message stored in mail box register 442 (S200). Although not shown in FIG. 13, the steps of the method can be variously rearranged in different embodiments. For instance, the order of steps S110, S120, S130, S140, and S150 can be rearranged to be performed in an order S130, S140, S110, S120 and S150.

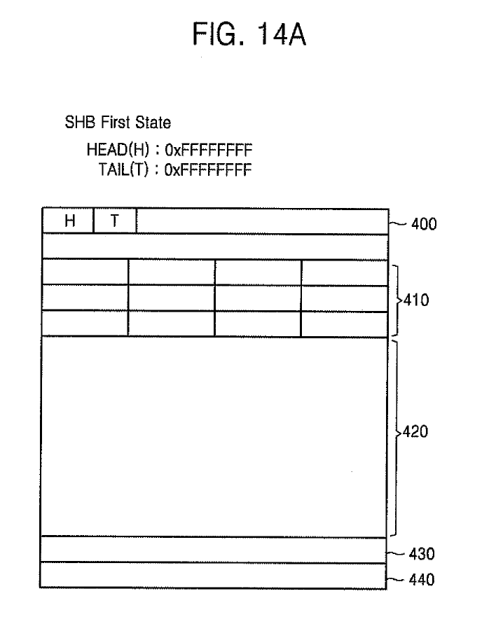

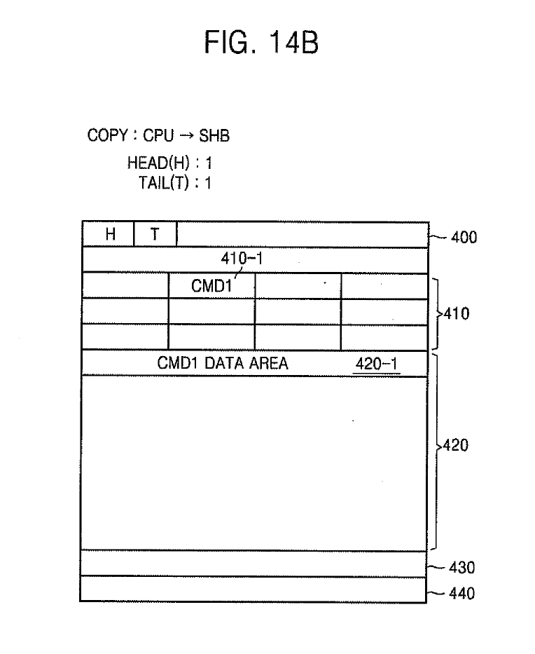

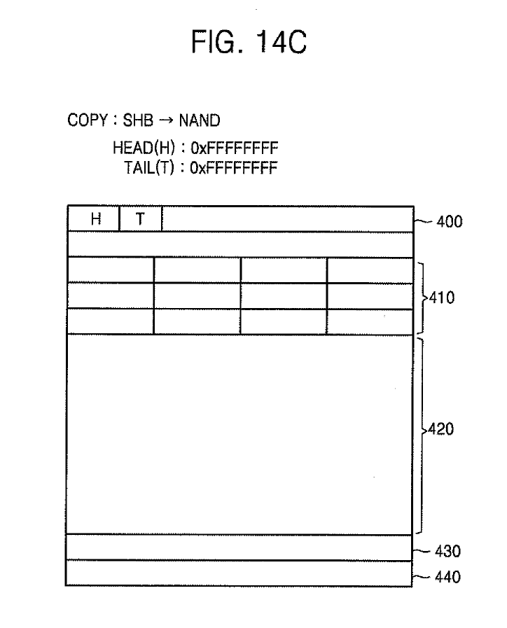

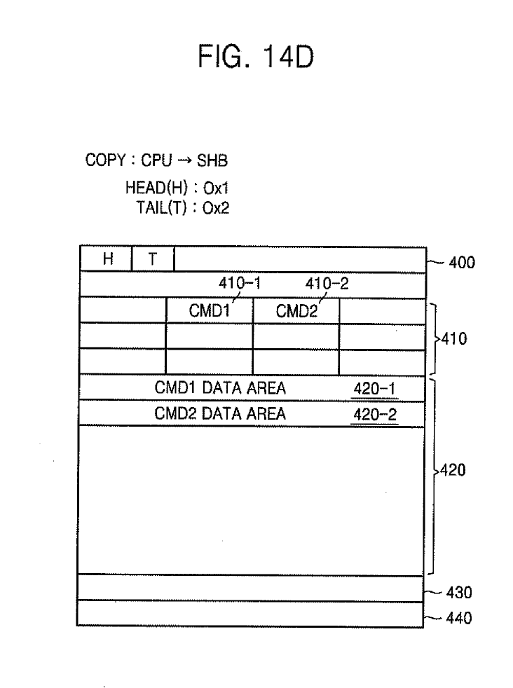

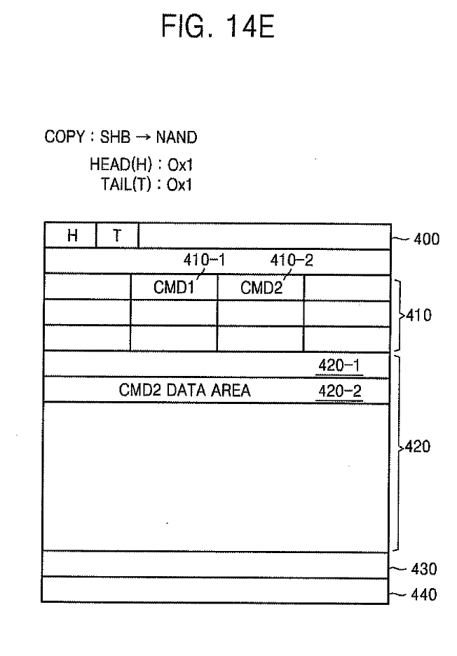

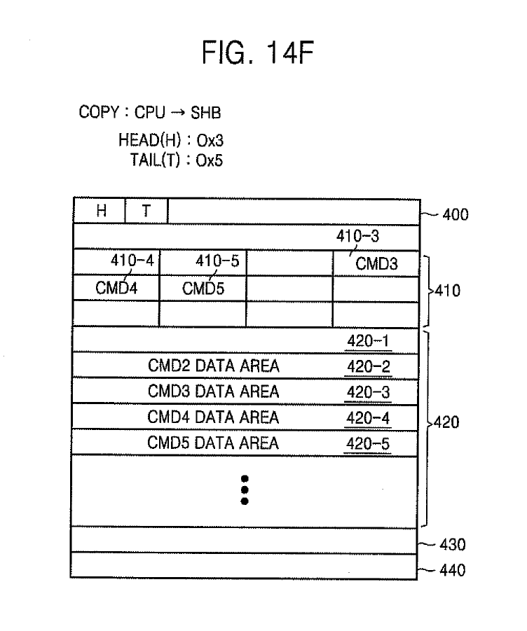

FIGS. 14a through 14f are memory diagrams illustrating data process procedures of the semiconductor device illustrated in FIG. 9. In particular, FIGS. 14a through 14f illustrate data stored in shared memory bank 43-2 of FIG. 10 during a write operation of semiconductor system 300. The procedures of FIGS. 14a through 14f are described below with reference to FIGS. 9 through 14f.

In the procedures of FIGS. 14a through 14c, it is assumed that first processor 320 initially has access authority for shared memory bank 43-2, and an initial state of shared memory bank 43-2 is empty as illustrated in FIG. 14a.

As illustrated in FIG. 14b, first processor 320 stores write data in first command data area 420-1 of command data block 420 (S110), generates a data packet, and transmits the generated data packet to memory bank 40. In this example, a start command index “H” and an end command index “T” are set to 1.

Multi-port memory device 40 decodes the received data packet, stores start command index H and end command index T in queue manager area 400 and stores a first access command CMD1 in a second storage area 410-1 of command area 410 according to the decoded data packet (S120).

First processor 320 then writes a message in mail box register 443 (S130), and multi-port memory device 40 outputs an activated interrupt signal to second processor 340 (S140) to indicate the presence of the message in mail box register 443. In response to the activated interrupt signal, second processor 340 performs an operation to obtain access authority for shared memory bank 43-2. After obtaining the access authority, second processor 340 reads and decodes the message in mail box register 443 (S150).

Based on the decoded message, second processor 340 reads first access command CMD1 stored in second storage area 410-1 of command area 410 (S160), reads write data stored in first command data area 420-1 according to first access command CMD1, and stores the write data in nonvolatile memory device 350 (S180).

Upon completion of the write operation, second processor 340 writes a message in mail box register 442 (S190), and multi-port memory device 40 outputs an activated interrupt signal to first processor 320 to indicate the presence of the message in mail box register 442. Following completion of the write operation, control block 450 of shared memory bank 43-2 becomes vacant as illustrated in FIG. 14c.

In response to the interrupt signal indicating the message in mail box register 442, first processor 320 performs operations to obtain access authority for shared memory bank 43-2. Upon obtaining the access authority, first processor 320 reads the message stored in mail box register 442 (S200).

In another example illustrated in FIG. 14d through 14f, first processor 320 stores first write data in first command data storage area 420-1, stores second write data in second command data storage area 420-2, generates a data packet comprising information for the first write data and the second write data, and transmits the generated data packet to multi-port memory device 40.

Multi-port memory device 40 samples a start command index (H:Ox1) and an end command index (T:Ox2) from the received data packet, stores the sampled indices in queue manager area 400, stores first access command CMD1 indicating a process for the first write data in second area 410-1 of command area 410, and stores second access command CMD2 indicating a process for the second write data in third area 410-2 of command area 410.

As illustrated in FIG. 14e, second processor 340 having access authority for shared memory bank 43-2 reads first access command CMD1 stored in second area 410-1 of command area 410 and writes the first write data stored in first command data area 420-1 in nonvolatile memory device 350 according to the read first access command CMD1. Consequently, only the second write data is left in second command data area 420-2.

Thereafter, as illustrated in FIG. 14f, first processor 320 having access authority for shared memory bank 43-2 writes third write data in a third command data storage area 420-3, writes fourth write data in a fourth command data storage area 420-4, writes fifth write data in a fifth command data storage area 420-5, generates a data packet comprising information for the third write data, the fourth write data and the fifth write data, and transmits the generated data packet to multi-port memory device 40.

Multi-port memory device 40 samples a start command index (H:Ox3) and an end command index (T:Ox5) from the received data packet, stores the sampled indices in queue manager area 400, stores a third access command CMD3 indicating a process for the third write data in a fourth region 410-3 of command area 410, stores a fourth access command CMD4 indicating a process for the fourth write data in a fifth area 410-4 of command area 410, and stores a fifth access command CMD5 indicating a process for the fifth write data in a sixth area 410-5 of command area 410.

Second processor 340 having access authority for shared memory bank 43-2 accesses shared memory bank 43-2 and writes second data, third data, fourth data, and fifth data in nonvolatile memory device 350 in a fixed order according to each access command CMD2, CMD3, CMD4 and CMD5.

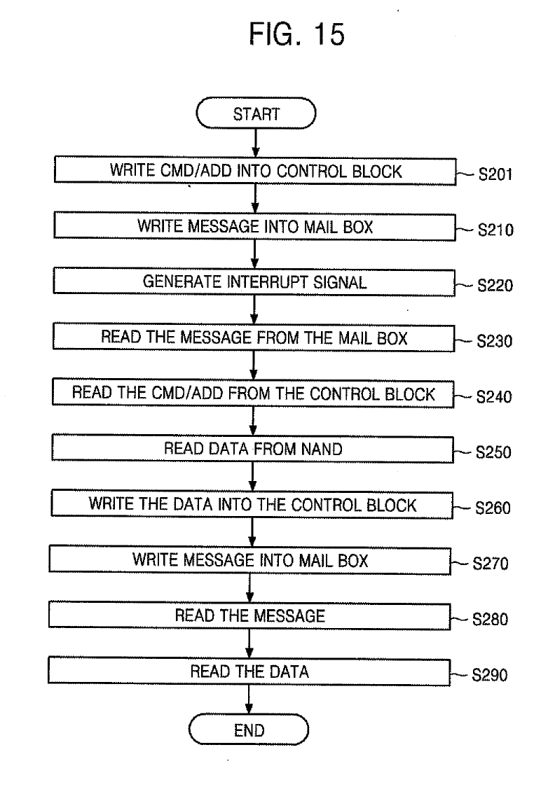

FIG. 15 is a flowchart illustrating a method of performing a read operation in semiconductor system 300 of FIG. 9. The read operation of FIG. 15 will be explained with reference to FIGS. 9 through 12 and 15.

In the method of FIG. 15, first processor 320 having access authority for shared memory bank 43-2 writes an access command in command area 410 of control block 450 (S201). First processor 320 also writes a message in mail box register 443 (S210).

Once the message is written in mail box register 443, multi-port memory device 40 transmits an activated interrupt signal to second processor 340 (S220). In response to the interrupt signal, second processor 340 performs a procedure for obtaining access authority for shared memory bank 43-2 in response to the activated interrupt signal.

Upon obtaining the access authority for shared memory bank 43-2, second processor 340 reads a message from mail box register 443 (S230) and reads an access command stored in command area 410 according to the message (S240). Second processor 340 then reads data from nonvolatile memory device 350 based on the access command (S250) and writes the data into command data area 420 of shared memory bank 43-2 according to the access command (S260). Thereafter, second processor 340 writes a message into mail box register 442 (S270), and multi-port memory device 40 then transmits an activated interrupt signal to first processor 320. In response to the interrupt signal, first processor 320 performs a procedure for obtaining access authority for shared memory bank 43-2.

Upon obtaining the access authority for shared memory bank 43-2, first processor 320 reads a message stored in mail box register 442 (S280) and reads data stored in command data area 420 according to the message (S290) to complete the read operation of semiconductor system 300.

In many of the above embodiments, a semiconductor system provides reduced power consumption compared with conventional systems by using an MLA to perform various memory access operations instead of a hard disk drive. In various embodiments, a semiconductor system uses a shared memory device to transmit information efficiently between the hard disk drive and the MLA, such as commands, addresses, and data.

The foregoing is illustrative of embodiments and is not to be construed as limiting thereof. Although a few embodiments have been described, those skilled in the art will readily appreciate that many modifications are possible in the embodiments without materially departing from the novel teachings and advantages of the inventive concept. Accordingly, all such modifications are intended to be included within the scope of the inventive concept as defined in the claims.

What is claimed is:

1. A semiconductor system, comprising:
a central processing unit (CPU);
a nonvolatile memory device;
a magnetic recording medium;
a memory device that processes data output from the CPU according to a dynamic random access (DRAM) protocol and outputs the processed data; and
an application specific integrated circuit (ASIC) that converts data output from the memory device into a format compatible with the nonvolatile memory device or a format compatible with the magnetic recording medium.

2. The semiconductor system of claim 1, wherein the ASIC comprises:
a first controller that communicates with the memory device according to the DRAM protocol;
a second controller that converts data output from the first controller into a format compatible with the nonvolatile memory device;
a third controller that converts the data output from the first controller into data compatible with the magnetic recording medium; and
a main processor that selectively enables the second controller and the third controller according to selection information output from the CPU.

3. The semiconductor system of claim 2, wherein the ASIC further comprises a fourth controller that converts data output from the second controller or the third controller into a format to be processed by a module under the control of the main processor.

4. The semiconductor system of claim 3, wherein the module is a computer expansion card, a display device, an MP3 player, or a universal serial bus device.

5. The semiconductor system of claim 1, further comprising a graphic card that reads data stored in the nonvolatile memory device or the magnetic recording medium through the ASIC.

6. The semiconductor system of claim 1, further comprising a universal serial bus (USB) device that reads data stored in the nonvolatile memory device or the magnetic recording medium through the ASIC.

7. The semiconductor system of claim 1, wherein the memory device comprises:
a first memory bank that can be accessed by the CPU;
a second memory bank that can be accessed by the ASIC; and
a shared memory bank that can be accessed by the CPU or the ASIC according to an access authority,
wherein the data output from the CPU is transferred to the ASIC via the shared memory bank.

8. The semiconductor system of claim 1, wherein the nonvolatile memory device, the memory device, and the ASIC are incorporated in a single integrated circuit.

9. The semiconductor system of claim 1, wherein the nonvolatile memory device comprises a flash memory device.

10. The semiconductor system of claim 1, wherein the magnetic recording medium comprises a hard disk.

11. A semiconductor device comprising:
a nonvolatile memory device;
a memory device that processes data according to a dynamic random access memory (DRAM) protocol; and
an application-specific integrated circuit (ASIC) that converts data output from the memory device into a format compatible with the nonvolatile memory device or a format compatible with a hard disk.

12. The semiconductor device of claim 11, wherein the ASIC comprises:
a first controller that communicates with the memory device according to the DRAM protocol;
a second controller that converts data output from the first controller into the format compatible with the nonvolatile memory device;
a third controller that converts the data output from the first controller into the format compatible with the hard disk; and
a main processor that selectively enables the second controller and the third controller according to selection information.

13. The semiconductor device of claim 11, wherein the nonvolatile memory device, the memory device, and the ASIC are implemented in a multi chip package (MCP).

14. The semiconductor device of claim 12, wherein the ASIC further comprises a fourth controller that converts data output from the second controller or the third controller into a format compatible with a module that operates under the control of the main processor.

15. The semiconductor device of claim 11, further comprising a shared memory region that receives memory access commands from the CPU, stores the memory access commands, and provides the ASIC or the CPU with access to the stored memory access commands according to an access authority.

16. The semiconductor device of claim 15, wherein the shared memory region resides in a multi-port memory device having a first port providing access to the ASIC and a second port providing access to the CPU.

17. A semiconductor system comprising:
a nonvolatile memory device;
a memory device comprising a first storage area and a second storage area;
a first processor configured to input an access command to the memory device for storage in the first storage area, and to input data corresponding to the access command to the memory device for storage in the second storage area; and
a second processor configured to read the access command from the first storage area, and to perform a data access operation on the nonvolatile memory device according to the access command.

18. The semiconductor system of claim 17, wherein the memory device further comprises a third storage area for storing an index indicating a size of the access command.

19. The semiconductor system of claim, 17, wherein the memory device further comprises a register block that stores messages transmitted between the first processor and the second processor.

20. The semiconductor system of claim 17, wherein the first processor comprises a central processing unit that inputs the access command to the memory device using a dynamic random access memory protocol, and wherein the second processor comprises an application specific integrated circuit that reads the access command from the memory device using the dynamic random access memory protocol.
